(19) United States
(12) Patent Application Publication
(10) Pub. No.: US 2017/0277397 A1
(43) Pub. Date: Sep. 28, 2017

(54) IMAGE DISPLAY DEVICE

(71) Applicant: TOYOTA JIDOSHA KABUSHIKI KAISHA, Toyota-shi (JP)

(72) Inventors: Masahisa ISHIBASHI, Nisshin-shi (JP); Yasutaka YOSHIMURA, Miyoshi-shi (JP)

(73) Assignee: TOYOTA JIDOSHA KABUSHIKI KAISHA, Toyota-shi (JP)

(21) Appl. No.: 15/417,303

(22) Filed: Jan. 27, 2017

(30) Foreign Application Priority Data
Mar. 22, 2016 (JP) 2016-057116

(51) Int. Cl. G06F 3/0481; G06T 5/00; G01C 21/36; G06F 3/0482

(52) U.S. Cl. CPC G06F 3/04817; G06F 3/0482; G06T 5/002; G01C 21/3676; G01C 21/367

(57) ABSTRACT

A display in an image display device displays images. A processor generates an image for display on the display. A map provider provide a map image to the processor. An item provider provides a menu icon to the processor. An acknowledging unit acknowledges a user input. The processor causes the display to display the map image received from the map provider, and, when the acknowledging unit acknowledges an input to display the menu icon, blurs the map image and displays the menu icon received from the item provider, superimposing the menu icon on the blurred map image.

### BACKGROUND

1. Technical Field

The present disclosure relates to image display devices provided in a vehicle and capable of displaying map images.

2. Background

An image display device capable of displaying a map image showing the position of the driver's vehicle is provided in a vehicle. Patent document 1 discloses a display information generator that generates information for display on an on-vehicle display. The display information generator as disclosed displays the position of the driver's vehicle and roads. As the vehicle speed increases, the display information generator generates information for displaying nearby roads other than the road that the driver's vehicle is traveling on in a blurred manner.

[patent document 1] JP2014-203318

When a user runs a menu selection function to use an another function while the image display device is displaying a map image showing the position of the driver's vehicle, the user may falsely recognize that the map display function is terminated, if the image display device terminates the display of the map image and displays a menu selection image.

### SUMMARY

The embodiments address the above-described issues, and a general purpose thereof is to provide a technology that allows a user to recognize that the map display function remains in operation and displays a menu in easy-to-view manner, when the menu selection function is run while the map image is being displayed.

An image display device according to an embodiment comprises: a display configured to display images; a processor configured to generate an image for display on the display; a map provider configured to provide a map image to the processor; an item provider configured to provide a menu icon to the processor; and an acknowledging unit configured to acknowledge a user input. The processor causes the display to display the map image received from the map provider on the display, and, when the acknowledging unit acknowledges an input to display the menu icon, blurs the map image and displays the menu icon received from the item provider, superimposing the menu icon on the blurred map image.

According to this embodiment, the map image displayed in the background of the menu icons indicates to the user that the map display function and the route guidance function remain in operation, better than when only the menu icons are displayed and the map image is not displayed. By blurring the map image and making it difficult to see, the menu icon is made easier to be viewed and used by the user.

The map provider may provide a map image indicating a position of a driver's vehicle to the processor, and, when the acknowledging unit acknowledges an input to display the menu icon, the processor blurs the map image updated in accordance with the position of the driver's vehicle and displays the menu icon received from the item provider, superimposing the menu icon on the blurred map image. This indicates to the user that the functions of displaying a map and displaying a route guidance remain in operation.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing the functional configuration of an image display device; and

FIGS. 2A and 2B illustrate images displayed on the display.

### DETAILED DESCRIPTION

Various embodiments now will be described. The embodiments are intended to be illustrative, not limiting.

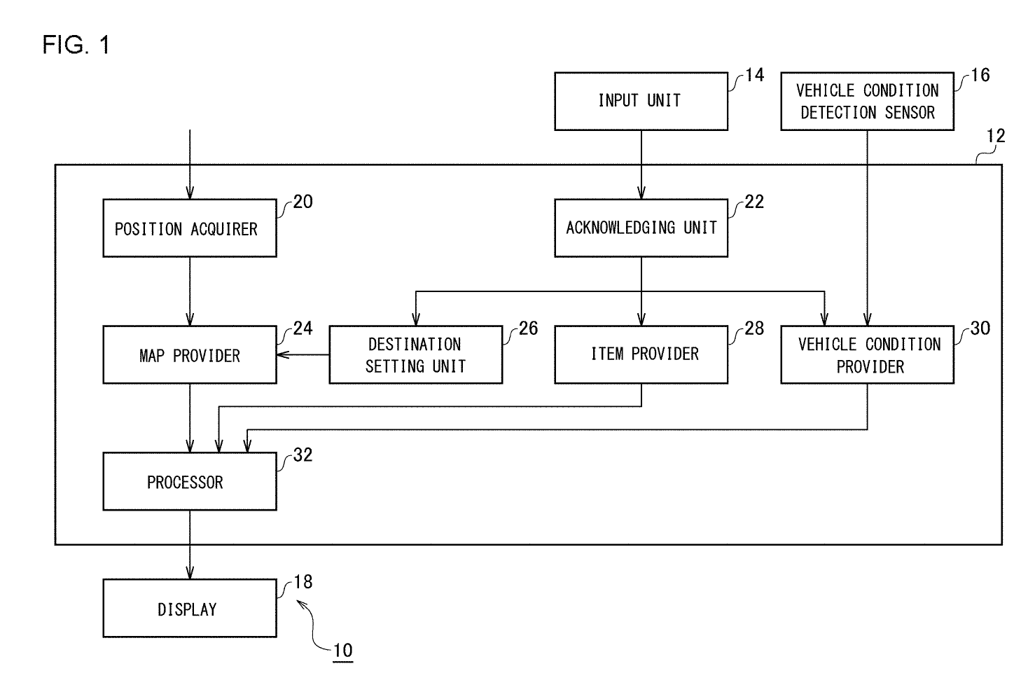

FIG. 1 is a diagram showing the functional configuration of an image display device 10. The image display device 10 is mounted on a vehicle. For example, a display 18 is provided in a dashboard located between the driver's seat and the front passenger seat. The image display device 10 generates a map image showing the position of the driver's vehicle as part of the navigation function. The image display device 10 also acknowledges a user input and allows the user to use on-vehicle functions.

The image display device 10 includes a controller 12, an input unit 14, and a display 18. The controller 12 is implemented in hardware such as devices and mechanical components such as a CPU and a memory of a computer, and in software such as a computer program.

The display 18 displays an image delivered from the controller 12. The display 18 is a touch-sensitive panel display configured to detect the contact of a user's finger. The input unit 14 is a means for receiving a user operation and is implemented by an icon displayed on the display 18 or a mechanical control switch.

The controller 12 includes a position acquirer 20, an acknowledging unit 22, a map provider 24, a destination setting unit 26, an item provider 28, a vehicle condition provider 30, and a processor 32.

The position acquirer 20 acquires the position of the driver's vehicle by using a Global Positioning System (GPS). The position acquirer 20 may derive the position of the driver's vehicle based on time information from multiple satellites. The acknowledging unit 22 acknowledges a user input from the input unit 14.

The map provider 24 provides the processor 32 with a map image for display on the display 18. The map provider 24 receives position information on the driver's vehicle from the position acquirer 20 and provides a map image showing the position of the driver's vehicle to the processor 32, adding a symbol indicating the position of the driver's vehicle to the map image.

The destination setting unit 26 sets a destination based on the user input and delivers the destination thus set to the map provider 24. When the map provider 24 receives the destination thus set from the destination setting unit 26, the map provider 24 adds information for guidance of a route to the destination to the map image. For example, the map provider 24 distinguishes the route to the destination from the other roads in the map image, showing the road to the destination in a larger size than the other roads and coloring the road to the destination differently.

When the acknowledging unit 22 acknowledges an input to display menu icons, the item provider 28 provides the menu icons to the processor 32. A menu icon is an object that can be used by the user to select a function and is displayed in part in a predetermined area on the display 18. Multiple menu icons associated with different function types are displayed. For example, an icon for making a transition to a screen for setting a destination, an icon for displaying vehicle condition information, an icon for using a telephone function, an icon for launching another application, etc. are displayed. When the user touches one of the menu icons with a finger, the function of the item associated with the user input is executed. Thus, the user can select a desired function from the menu icons and use the selected function accordingly.

The vehicle condition provider 30 provides the vehicle condition information received from a vehicle condition detection sensor 16 to the processor 32. Further, the vehicle condition provider 30 may receive vehicle condition information from an on-vehicle ECU. The vehicle condition information includes a vehicle speed, travel distance, battery level of the on-vehicle battery, images captured around the vehicle, intra-vehicle temperature, etc.

The processor 32 generates an image for display on the display 18 and delivers the generated image to the display 18. The processor 32 displays the map image showing the position of the driver's vehicle received from the map provider 24 so as to display a map around the driver's vehicle.

When the acknowledging unit 22 acknowledges an input to display the menu icons, the processor 32 displays the menu icons, superimposing the menu icons on the blurred map image and blurring the map image. By blurring the map image, viewability of the map image is lowered. Superimposition of the clear menu icons on the blurred map image by the processor 32 makes it easy for the user to find the menu icons. The map image displayed in the background of the menu icons indicates to the user that the map display function and route guidance function remain in operation, better than when only the menu icons are displayed and the map image is not displayed.

When the acknowledging unit 22 acknowledges an input to display the menu icons, the processor 32 updates the map image displayed in a blurred manner in accordance with the position of the driver's vehicle and scrolls the map image displayed on the display 18, while the vehicle is traveling. This indicates to the user that the functions of displaying a map and a route guidance remain in operation while the menu icons are displayed.

A description will be given of a process of blurring a map image. The processor 32 blurs a map image by averaging pixel values of adjacent pixels in the map image. In one variation of the blurring process, the processor 32 may derive an average of 5×5 pixels, i.e. a set of pixels within a range of 5 pixels in the vertical and horizontal directions. Alternatively, the processor 32 may average a set of 10×10 pixels in the vertical and horizontal directions. In accordance with the variation of the blurring process, the processor 32 may total the pixel values of adjacent pixels and distribute the pixel values in a certain ratio. In further accordance with the variation of the blurring process, the processor 32 may average the pixel values of adjacent pixels if a difference between the pixel values of the adjacent pixels is equal to or more than a predetermined threshold value (e.g., if a difference in any of the RGB values is equal to more than the threshold value).

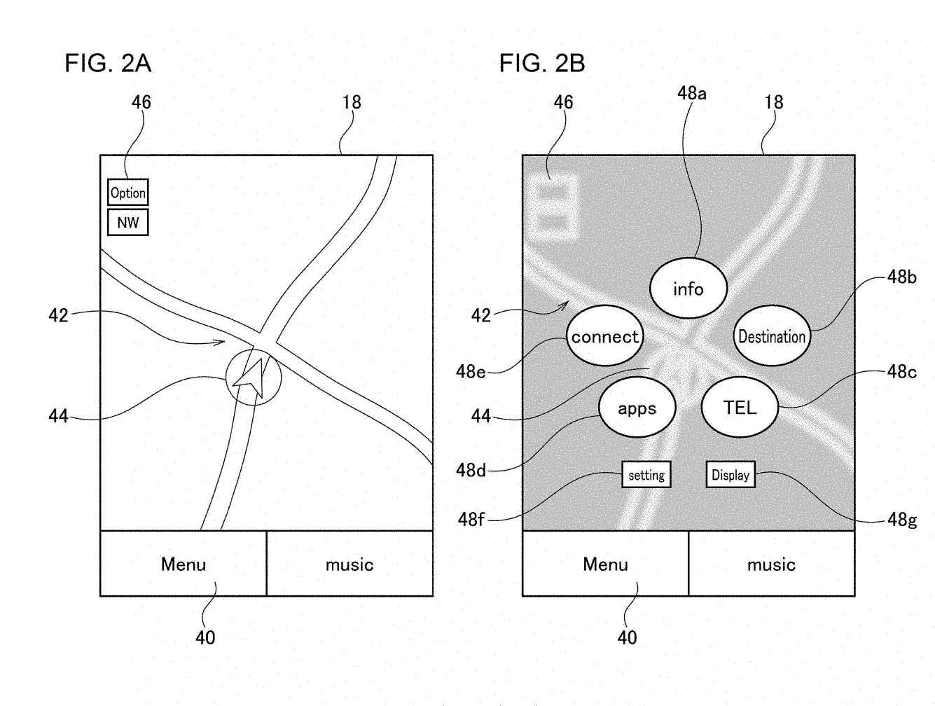

FIGS. 2A and 2B illustrate images displayed on the display 18. FIG. 2A shows the display 18 displaying a map image 42 and the position of the driver's vehicle. The map image 42 is a map around the driver's vehicle. A driver's vehicle symbol 44 is shown near the center of the display 18 to indicate the position of the driver's vehicle. A map manipulation icon 46 is shown in the upper left corner of the map image 42 and is an object that can be controlled to provide settings of the map image 42. The user can change the scale or orientation of the map image 42 by tapping the map manipulation icon 46 with a finger.

A menu display icon 40 is located in the bottom left corner of the display 18. When the user taps the menu display icon 40 with a finger, the acknowledging unit 22 acknowledges an input to display the menu icons, the menu icons are displayed accordingly. The image display device 10 may be provided with a mechanical menu display switch.

FIG. 2B shows the display 18 displaying the menu icons. When the menu display icon 40 is tapped and the acknowledging unit 22 acknowledges an input to display the menu icons accordingly, the item provider 28 provides the menu icons to the processor 32. The processor 32 generates an image in which the map image 42 is blurred and the menu icons are superimposed on the map image 42. The processor 32 delivers the generated image to the display 18. The display 18 displays the image received from the processor 32.

The display 18 superimposes menu icons 48a, 48b, 48c, 48d, 48e, 48f, and 48g (referred to as “menu icons 48” if the icons are not distinguished from each other) on the map image 42. Because the map image 42 is blurred, the user can easily find the menu icons 48 that are relatively clear and so find it easy to use the menu icons 48.

The menu icon 48a is an icon to display vehicle condition information. The menu icon 48b is an icon to display a screen for setting a destination. The menu icon 48c is an icon to display a screen for placing a telephone call. The menu icon 48d is an icon to launch another application. The menu icon 48e is an icon to acquire latest road information by connecting to a network. The menu icon 48f is an icon to set the functions of the image display device 10. The menu icon 48g is an icon to return to the original map image 42. When the user taps one of the menu icons 48, the function associated with the type of the menu icon 48 is launched.

The blurred map image 42 is displayed in the background of the menu icons 48 in a blurred manner. This reduces the likelihood that the user falsely recognizes that the display of the map image 42 is terminated. In this way, the image display device 10 is capable of indicating to the user that the functions of displaying the position of the driver's vehicle on the map and displaying a route guidance remain in operation, better than the case where the map image 42 is not displayed in the background.

Even when the map image 42 is displayed in the background of the menu icons 48, the map image 42 is updated and scrolled in accordance with the position of the driver's vehicle as the driver's vehicle moves during a travel. When the driver's vehicle moves, the map image 42 on the display 18 is scrolled with the driver's vehicle symbol 44 remaining displayed near the center of the display 18. This allows the image display device 10 to indicate to the user that the map display function and route guidance function remain in operation, while displaying the menu icons 48 at the same time.

When the user touches the menu icon 48g, i.e., when the acknowledging unit 22 acknowledges an input to terminate the display of the menu icons 48, the display of the menu icons 48 is terminated and the map image 42 not blurred is displayed again as shown in FIG. 2A. The map image 42 has been updated in accordance with the position of the driver's vehicle while it is being displayed in the background of the menu icons 48. Therefore, the map image 42 is merely no longer blurred upon termination of the process. The map image 42 is not scrolled markedly when the images are switched so that the stress experienced by the user is mitigated.

Given above is an explanation based on exemplary embodiments. The embodiment is intended to be illustrative only and it will be obvious to those skilled in the art that various modifications to constituting elements and processes could be developed and that such modifications are also within the scope of the present disclosure.

What is claimed is:

1. An image display device comprising:
a display configured to display images;
a processor configured to generate an image for display on the display;
a map provider configured to provide a map image to the processor;
an item provider configured to provide a menu icon to the processor; and
an receiver configured to acknowledge a user input, wherein
the processor causes the display to display the map image received from the map provider on the display, and, when the receiver acknowledges an input to display the menu icon, blurs the map image and displays the menu icon received from the item provider, superimposing the menu icon on the blurred map image.

2. The image display device according to claim 1, wherein
the map provider provides the map image indicating a position of a driver's vehicle to the processor, and
when the receiver acknowledges an input to display the menu icon, the processor blurs the map image updated in accordance with the position of the driver's vehicle and displays the menu icon received from the item provider, superimposing the menu icon on the blurred map image.
